(19) United States
(12) Patent Application Publication
(10) Pub. No.: US 2025/0067294 A1
(43) Pub. Date: Feb. 27, 2025

(54) FRAME JOINT STRUCTURE

(71) Applicants: HONDA MOTOR CO., LTD., Tokyo (JP); H-ONE CO., LTD., Saitama-shi, Saitama (JP)

(72) Inventors: Ryosuke Itai, Wako-shi, Saitama-ken (JP); Itsuo Yoshida, Wako-shi, Saitama-ken (JP); Seiji Yoshida, Wako-shi, Saitama-ken (JP); Toshiya Seki, Wako-shi, Saitama-ken (JP); Katsutoshi Masuda, Saitama-shi, Saitama-ken (JP); Masashi Ogawa, Saitama-shi, Saitama-ken (JP)

(21) Appl. No.: 18/722,938

(22) PCT Filed: Dec. 27, 2021
(86) PCT No.: PCT/JP2021/048464

§ 371 Date: Jun. 21, 2024

(51) Int. Cl. F16B 9/00

(52) U.S. Cl. CPC F16B 9/01

(57) ABSTRACT

A frame joint structure includes a connecting member positioned adjacent to a joint between a first frame and a second frame. The connecting member has a first joint surface that abuts only one flat surface of the first frame, and a second joint surface that is integrally continuous with the first joint surface and abuts only one flat surface of the second frame. The connecting member is joined to the first frame and the second frame by a first joining member (such as adhesive).

### TECHNICAL FIELD

The present invention relates to a frame joint structure for joining frame members for an automobile.

### BACKGROUND ART

A frame of an automobile is formed by joining a plurality of frame members. Various frame joint structures have been proposed for firmly joining the plurality of frame members. For example, JP 2007-514607 A discloses a frame joint structure having receiving openings for inserting a plurality of rod-shaped frame members, and planar welding regions for joining to the plurality of frame members.

### SUMMARY OF THE INVENTION

The frame members joined by welding have thermal strain, which may cause quality problems. Further, the conventional frame joint structure requires welding equipment, which causes a problem that the equipment cost is increased.

As a joining method for avoiding the problem caused by welding, a method using an adhesive is considered. However, in the joint structure in which the frame members are received in the receiving openings, the adhesive may be scraped off from the joint surfaces by the receiving openings, which causes a problem that the joint strength is not stable.

The present invention has the object of solving the aforementioned problem.

An aspect of the present disclosure resides in a frame joint structure that joins together a first frame including a plurality of planar portions on an outer periphery of the first frame, and a second frame including a plurality of planar portions on an outer periphery of the second frame, the frame joint structure comprising a connecting member disposed adjacent to a joint portion between the first frame and the second frame, wherein the connecting member includes a first joint surface that abuts on only one of the planar portions of the first frame, and a second joint surface that is integrally connected to the first joint surface and abuts on only one of the planar portions of the second frame, and the connecting member is joined to the first frame and the second frame by a first joining member.

The frame joint structure of the above aspect can suppress scraping of the first joining member when the connecting member is attached to the first frame or the second frame, and therefore can increase the joint strength. In addition, in the frame joint structure of the above aspect, since the structure of the connecting member is simple and welding equipment is not required, the manufacturing cost can be suppressed.

### BRIEF DESCRIPTION OF THE DRAWINGS

FIG. 1 is a perspective view of a frame joint structure according to a first embodiment;

FIG. 2 is a perspective view showing the lower side of the frame joint structure of FIG. 1;

FIG. 3A is a perspective view of a first connecting member of the frame joint structure of FIG. 1, and FIG. 3B is a perspective view of the first connecting member of FIG. 3A as viewed from a different angle;

FIG. 4 is a development view of the first connecting member of FIG. 3A;

FIG. 5 is a perspective view of a frame joint structure according to a second embodiment;

FIG. 6 is a perspective view showing the lower side of the frame joint structure of FIG. 5;

FIG. 7 is a perspective view of a frame joint structure according to a third embodiment;

FIG. 8 is a perspective view of the frame joint structure of FIG. 7 as viewed from a different direction; and

FIG. 9 is a perspective view of a frame joint structure according to a fourth embodiment.

### DETAILED DESCRIPTION OF THE INVENTION

### First Embodiment

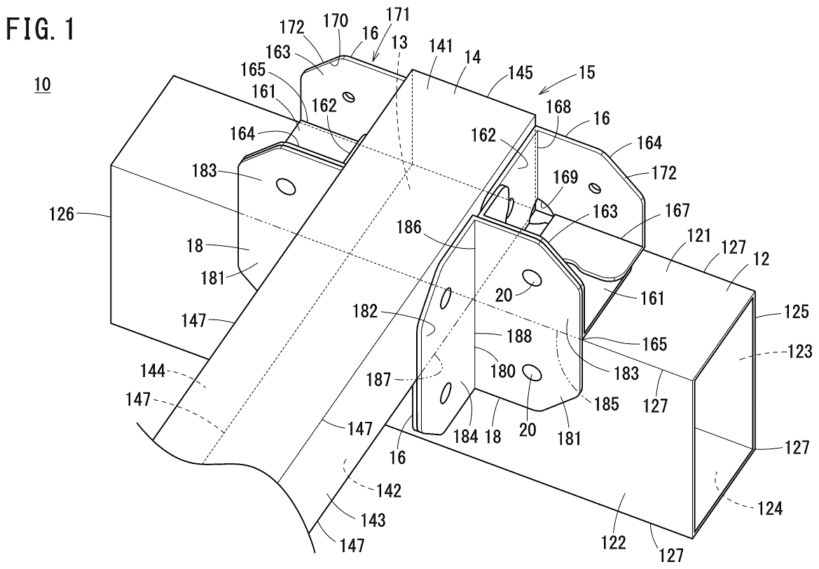

As shown in FIG. 1, a frame joint structure 10 of the present embodiment is used for joining two frames (a first frame 12 and a second frame 14). The first frame 12 and the second frame 14 are used for a vehicle body frame of an automobile, for example. The frame joint structure 10 is used for manufacturing the vehicle body frame, for example.

The first frame 12 is a square pipe having a rectangular cross-sectional shape. The first frame 12 includes, on the outer periphery thereof, a first surface 121 (a first planar portion), a second surface 122, a third surface 123, and a fourth surface 124. Ridge line portions 127 are formed at the boundaries between the first surface 121 to the fourth surface 124. The outer periphery of the first frame 12 is bent by 90° at the ridge line portions 127.

Although not particularly limited, in the first frame 12 of FIG. 1, the widths (the dimension from one ridge line portion 127 to the other ridge line portion 127) of the second surface 122 and the third surface 123 are larger than the widths of the first surface 121 and the fourth surface 124. For convenience of description, a case where the first frame 12 extends linearly from a first end portion 125 to a second end portion 126, which is on the other side in the extending direction, will be described as an example. However, the present embodiment is not limited to the illustrated example, and the first frame 12 may be curved at a portion other than the frame joint structure 10.

The second frame 14 is a square pipe having a rectangular cross section. The second frame 14 includes, on the outer periphery thereof, a fifth surface 141, a sixth surface 142 (a second planar portion), a seventh surface 143, and an eighth surface 144. Ridge line portions 147 are formed at the boundaries between the fifth surface 141 to the eighth surface 144. The outer periphery of the second frame 14 is bent by 90° at the ridge line portions 147. Although not particularly limited, the fifth surface 141 to the eighth surface 144 may have the same width. The second frame 14 may have a square cross-sectional shape. The second frame 14 extends linearly at least in the vicinity of an end portion 145. The end portion 145 of the second frame 14 has an end surface that is cut perpendicularly to the extending direction of the second frame 14.

The sixth surface 142 of the second frame 14 abuts on the first surface 121 of the first frame 12 in a surface contact manner. The second frame 14 abuts on the first frame 12 so that the end portion 145 coincides with the position of the third surface 123 of the first frame 12. In the frame joint structure 10 of the present embodiment, the first frame 12 and the second frame 14 form a T-shape in a plan view. The portion where the first frame 12 and the second frame 14 abut on each other constitutes a joint portion 13.

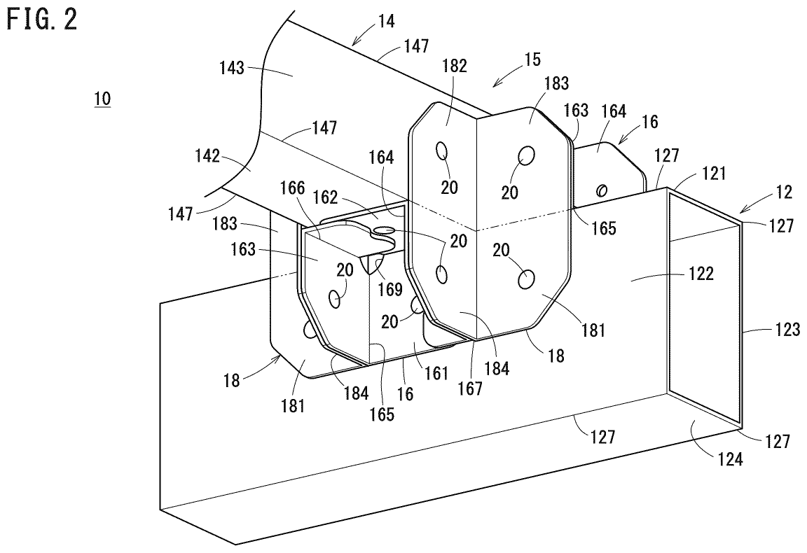

As shown in FIGS. 1 and 2, the frame joint structure 10 includes a connecting unit 15 disposed so as to surround the joint portion 13. The connecting unit 15 abuts on a plurality of planar portions of the first frame 12 and the second frame 14 near the joint portion 13. The connecting unit 15 of the present embodiment abuts on the first surface 121 and the second surface 122 of the first frame 12, and the sixth surface 142, the seventh surface 143, and the eighth surface 144 of the second frame 14.

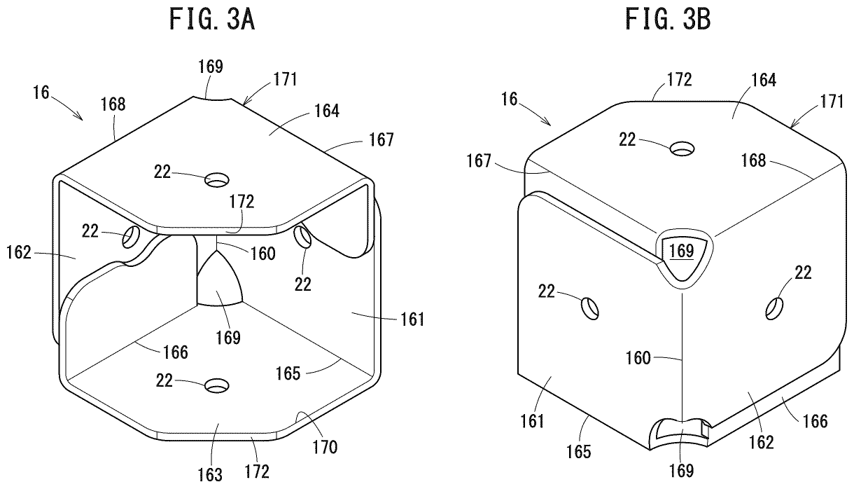

The connecting unit 15 is formed by connecting a plurality of first connecting members 16 and second connecting members 18. As shown in FIG. 3A and FIG. 3B, the first connecting member 16 has a dice shape with a part thereof cut out. The first connecting member 16 includes a first joint surface 161, a second joint surface 162, a first reinforcing surface 163, and a second reinforcing surface 164. The first connecting member 16 includes a chamfered portion 170 formed by cutting out two surfaces constituting a cube. The inner surface sides of the first joint surface 161, the second joint surface 162, the first reinforcing surface 163, and the second reinforcing surface 164 are exposed through the chamfered portion 170. The chamfered portion 170 reduces the volume occupied by the first connecting member 16, and prevents interference between the first connecting member 16 and external members.

The first joint surface 161 and the second joint surface 162 are each formed in a rectangular plate shape. The first joint surface 161 abuts on one planar portion of the first frame 12. The second joint surface 162 abuts on one planar portion of the second frame 14. The second joint surface 162 is integrally connected to the first joint surface 161 via a bent portion 160. The first joint surface 161 and the second joint surface 162 form 90° at the bent portion 160.

The first reinforcing surface 163 is perpendicular to the first joint surface 161 and the second joint surface 162. The first reinforcing surface 163 is bridged between one end edge 165 of the first joint surface 161 and one end edge 166 of the second joint surface 162. The second reinforcing surface 164 is perpendicular to the first joint surface 161 and the second joint surface 162. The second reinforcing surface 164 is integrally connected to another end edge 168 of the second joint surface 162. The other end of the second reinforcing surface 164 is connected to an end edge 167 of the first joint surface 161.

The first connecting member 16 includes cutout portions 172 formed by obliquely cutting out a corner portion of the first reinforcing surface 163 and a corner portion of the second reinforcing surface 164. The cutout portions 172 are inclined with respect to the first joint surface 161 and the second joint surface 162. The cutout portions 172 prevent interference between the first connecting member 16 and peripheral members by suppressing outward protrusion of the first reinforcing surface 163 and the second reinforcing surface 164.

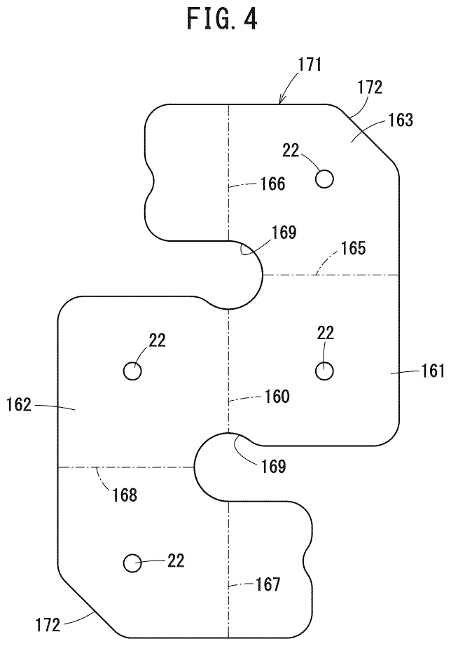

The first connecting member 16 is formed by bending a single plate member 171 shown in FIG. 4. The plate member 171 is a metallic plate having a predetermined thickness (for example, a thickness of 1 mm to 5 mm). In order to facilitate the bending process, the first connecting member 16 includes a cutout portion 169 formed at a corner portion where the one end edge 165 of the first joint surface 161 and the one end edge 166 of the second joint surface 162 intersect with each other. Further, another cutout portion 169 is formed at a corner portion formed between the other end edge 167 of the first joint surface 161 and the other end edge 168 of the second joint surface 162. The cutout portions 169 are each formed in an arc shape in the developed plate member 171.

The first connecting member 16 is joined to a joint target by an adhesive, which is a first joining member. As shown in FIG. 3A and FIG. 3B, the first connecting member 16 includes a through hole 22 in the center of each of the first joint surface 161, the second joint surface 162, the first reinforcing surface 163, and the second reinforcing surface 164. The through hole 22 is a hole through which a second joining member 20 is inserted. Therefore, the first connecting member 16 is joined to the target by the second joining member 20 together with the first joining member (for example, an adhesive). The second joining member 20 is, for example, a rivet. The second joining member 20 may be a bolt, a screw, or the like.

As shown in FIG. 1, the second connecting member 18 is formed of a plate body bent in an L-shape. The second connecting member 18 includes a bent portion 180, a third joint surface 181, a fourth joint surface 182, a third reinforcing surface 183, and a fourth reinforcing surface 184. The bent portion 180 extends so as to cross the center of the second connecting member 18. The second connecting member 18 is bent by 90° at the bent portion 180. The third joint surface 181 and the fourth joint surface 182 are connected to each other via the bent portion 180. The third reinforcing surface 183 is formed on the same plane as the third joint surface 181. The third reinforcing surface 183 extends integrally from a first side edge 185 of the third joint surface 181. Further, the third reinforcing surface 183 is connected to a first side edge 186 of the fourth joint surface 182 (the bent portion 180). The third reinforcing surface 183 is perpendicular to the fourth joint surface 182.

The fourth reinforcing surface 184 is formed on the same plane as the fourth joint surface 182. The fourth reinforcing surface 184 extends from a second side edge 188 of the third joint surface 181. The fourth reinforcing surface 184 is perpendicular to the third joint surface 181. The fourth reinforcing surface 184 is integrally connected to a second side edge 187 of the third joint surface 181 (the bent portion 180).

The second connecting member 18 includes a through hole 22 in the center of each of the third joint surface 181, the fourth joint surface 182, the third reinforcing surface 183, and the fourth reinforcing surface 184. The second joining member 20 (for example, a rivet) is inserted through the through hole 22. The second connecting member 18 is joined to the target by the adhesive, which is the first joining member, and the second joining members 20.

As shown in FIGS. 1 and 2, the connecting unit 15 of the present embodiment includes three first connecting members 16 and two second connecting members 18. The first connecting members 16 are disposed at portions where the sides of the peripheral edge of the joint portion 13 between the first frame 12 and the second frame 14 appear. In the first first connecting member 16, the first joint surface 161 abuts on the first surface 121 of the first frame 12, and the second joint surface 162 abuts on the seventh surface 143 of the second frame 14. In the second first connecting member 16, the first joint surface 161 abuts on the first surface 121 of the first frame 12, and the second joint surface 162 abuts on the eighth surface 144 of the second frame 14. In the third first connecting member 16, the first joint surface 161 abuts on the second surface 122 of the first frame 12, and the second joint surface 162 abuts on the sixth surface 142 of the second frame 14.

In the present embodiment, the dimension between the first reinforcing surface 163 and the second reinforcing surface 164, which is the width of the first connecting member 16, is the same as the width of the first surface 121 of the first frame 12 and the width of the sixth surface 142 of the second frame 14. Therefore, the first reinforcing surface 163 of the first first connecting member 16 is disposed on the same plane as the second surface 122 of the first frame 12. The second reinforcing surface 164 of the second first connecting member 16 is disposed on the same plane as the third surface 123 of the first frame 12. As shown in FIG. 2, in the third first connecting member 16, the first reinforcing surface 163 is disposed on the same plane as the eighth surface 144 of the second frame 14, and the second reinforcing surface 164 is disposed on the same plane as the seventh surface 143 of the second frame 14.

The two second connecting members 18 are each disposed for two adjacent first connecting members 16 and connect these members. Each of the second connecting members 18 abuts on the first frame 12 and the second frame 14 and is joined to these frames. That is, the second connecting member 18 on the side toward the viewer in the plane of FIG. 1 abuts on the first reinforcing surface 163 of the first first connecting member 16 and the second reinforcing surface 164 of the third first connecting member 16 and connects these surfaces.

The first connecting members 16 and the second connecting members 18 are joined to the first frame 12 and the second frame 14 by the first joining member made of an adhesive and the second joining members 20 (for example, rivets), and form the connecting unit 15 surrounding the joint portion 13.

In the frame joint structure 10 of the present embodiment described above, the plurality of first connecting members 16 and second connecting members 18, to which the adhesive has been applied, are brought into contact with the first frame 12 and the second frame 14 in an abutment manner, and the plurality of first connecting members 16 are connected together by the second connecting members 18. As described above, the frame joint structure 10 includes no receiving opening, and therefore, the connecting unit 15 surrounding the periphery of the joint portion 13 between the first frame 12 and the second frame 14 can be formed without performing the operation of scraping off the adhesive, which is the first joining member. As a result, the frame joint structure 10 can join the first frame 12 and the second frame 14 with sufficient strength.

### Second Embodiment

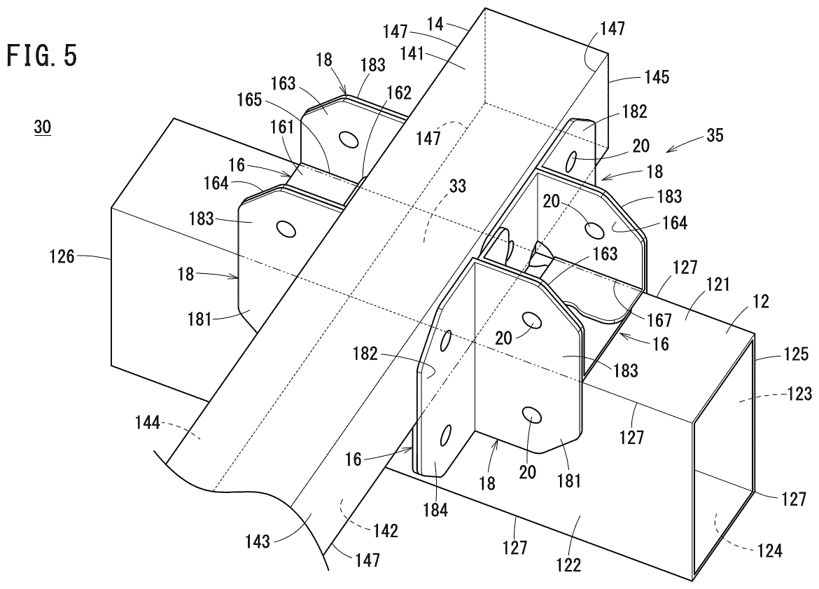

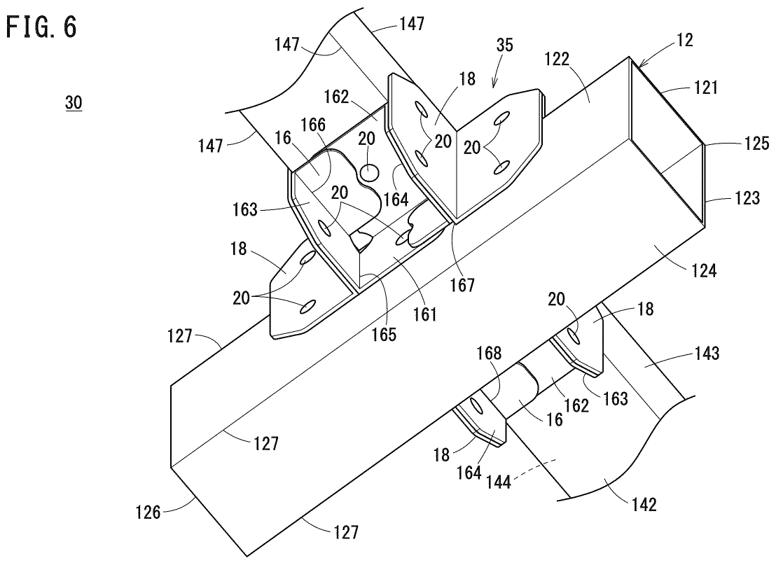

As shown in FIGS. 5 and 6, a frame joint structure 30 of the present embodiment is applied to a portion where the first frame 12 and the second frame 14 are joined to each other in a cross shape in a plan view. It should be noted that, in the frame joint structure 30 of the present embodiment, the same configurations as those of the frame joint structure 10 described with reference to FIGS. 1 to 3 are denoted by the same reference numerals, and detailed description thereof will be omitted.

The frame joint structure 30 includes a joint portion 33 where the first surface 121 of the first frame 12 abuts on the sixth surface 142 of the second frame 14 in a surface contact manner. The frame joint structure 30 includes a connecting unit 35 surrounding the joint portion 33. The connecting unit 35 includes four first connecting members 16 and four second connecting members 18.

Each of the first connecting members 16 is disposed such that the bent portion 160 thereof abuts against each side of the peripheral edge of the joint portion 33. The joint portion 33 has four sides on the peripheral edge thereof. Therefore, four first connecting members 16 are disposed corresponding to the four sides of the joint portion 33. In each of the first connecting members 16, the first joint surface 161 abuts on the first frame 12 and the second joint surface 162 abuts on the second frame 14. The first connecting members 16, the first frame 12, and the second frame 14 are joined together by an adhesive (the first joining member) and the second joining members 20 (rivets).

The second connecting members 18 are each disposed between two adjacent first connecting members 16. The third reinforcing surface 183 and the fourth reinforcing surface 184 of the second connecting member 18 abut on and are joined to the first reinforcing surface 163 or the second reinforcing surface 164 of the two first connecting members 16. Further, the third joint surface 181 of the second connecting member 18 abuts on the first frame 12. The fourth joint surface 182 of the second connecting member 18 abuts on the second frame 14. The four second connecting members 18 connect the four first connecting members 16 to form the connecting unit 35.

As described above, according to the frame joint structure 30 of the present embodiment as well, the connecting unit 35 surrounding the periphery of the joint portion 33 between the first frame 12 and the second frame 14 can be formed without performing the operation of scraping off the adhesive. As a result, the frame joint structure 30 can join the first frame 12 and the second frame 14 with sufficient strength.

### Third Embodiment

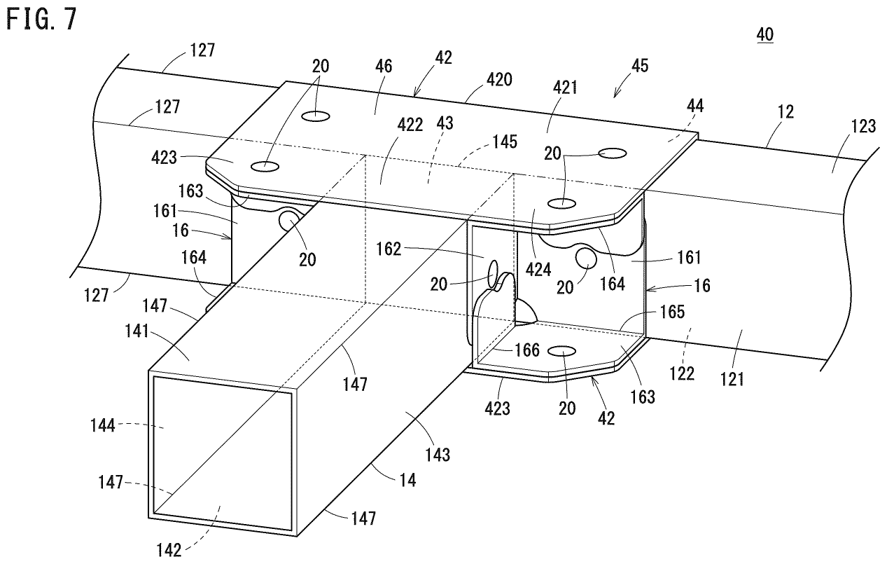

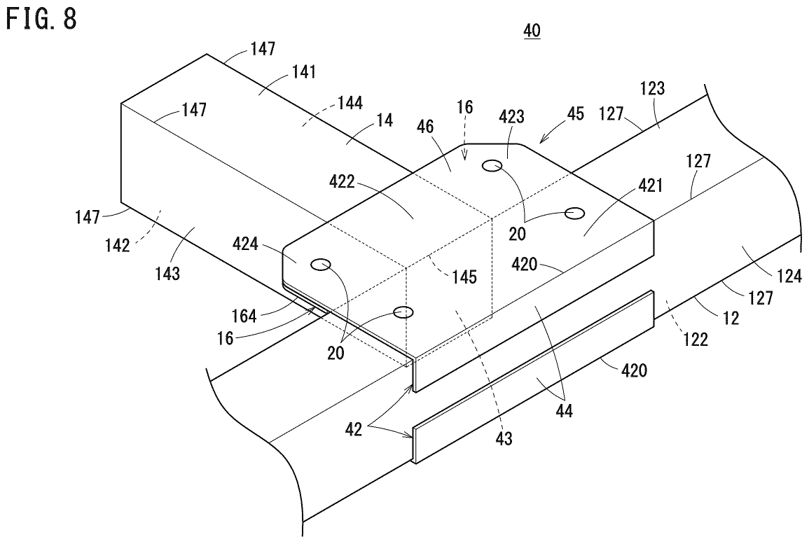

As shown in FIGS. 7 and 8, a frame joint structure 40 of the present embodiment is applied to a joint portion 43 where the end portion 145 of the second frame 14 is abutted against the first surface 121 of the first frame 12. It should be noted that, in the frame joint structure 40 of the present embodiment, the same configurations as those of the frame joint structure 10 described with reference to FIGS. 1 to 3 are denoted by the same reference numerals, and detailed description thereof will be omitted.

In the frame joint structure 40, the second frame 14 is arranged perpendicularly to the first frame 12. The seventh surface 143 and the eighth surface 144 of the second frame 14 are perpendicular to the first surface 121 of the first frame 12. Further, the fifth surface 141 of the second frame 14 and the third surface 123 of the first frame 12 form the same plane. Furthermore, the sixth surface 142 of the second frame 14 and the second surface 122 of the first frame 12 form the same plane.

The frame joint structure 40 includes a connecting unit 45 surrounding the joint portion 43. The connecting unit 45 includes two first connecting members 16 and two third connecting members 42. The third connecting member 42 is a plate member. As shown in FIG. 8, the third connecting member 42 has an L-shape bent by 90° at a bent portion 420. The third connecting member 42 includes a support surface 44 and a main surface 46. The support surface 44 is integrally connected to the main surface 46 via the bent portion 420. The support surface 44 abuts on and is joined to the fourth surface 124 of the first frame 12.

The main surface 46 includes a fifth joint surface 421, a sixth joint surface 422, a fifth reinforcing surface 423, and a sixth reinforcing surface 424. These surfaces are formed on the same plane to form the flat main surface 46. The fifth joint surface 421 of the third connecting member 42 is a portion that abuts on the third surface 123 or the second surface 122 of the first frame 12. The sixth joint surface 422 is a portion that abuts on the fifth surface 141 or the sixth surface 142 of the second frame 14. The fifth reinforcing surface 423 extends from one side portion of the sixth joint surface 422. The fifth reinforcing surface 423 connects one edge of the fifth joint surface 421 and one edge of the sixth joint surface 422. The fifth reinforcing surface 423 abuts on and is joined to the first reinforcing surface 163 or the second reinforcing surface 164 of the first connecting member 16.

The sixth reinforcing surface 424 extends from the other side portion of the sixth joint surface 422. The sixth reinforcing surface 424 connects the other edge of the fifth joint surface 421 and the other edge of the sixth joint surface 422. The sixth reinforcing surface 424 abuts on and is joined to the first reinforcing surface 163 or the second reinforcing surface 164 of the first connecting member 16.

One of the third connecting members 42 is disposed in contact with the third surface 123 of the first frame 12. The other of the third connecting members 42 is disposed in contact with the second surface 122 of the first frame 12. One of the third connecting members 42 and the other of the third connecting members 42 are disposed so as to face each other with the first frame 12 and the second frame 14 interposed therebetween.

As shown in FIG. 7, the first connecting members 16 are each sandwiched between the two third connecting members 42. One of the first connecting members 16 is disposed at a corner where the first surface 121 of the first frame 12 and the seventh surface 143 of the second frame 14 intersect. The other of the first connecting members 16 is disposed at a corner where the first surface 121 of the first frame 12 and the eighth surface 144 of the second frame 14 intersect. In the first connecting member 16, the first joint surface 161 abuts on the first frame 12, and the second joint surface 162 abuts on the second frame 14. In addition, in the first connecting member 16, the first reinforcing surface 163 and the second reinforcing surface 164 respectively abut on the fifth reinforcing surface 423 and the sixth reinforcing surface 424 of the third connecting member 42. The two first connecting members 16 are connected to each other by the two third connecting members 42.

As described above, the frame joint structure 40 of the present embodiment is also configured by combining the first connecting members 16 and the third connecting members 42 each abutting on two of the planar portions of the first frame 12 or the second frame 14. Therefore, according to the frame joint structure 40, the connecting unit 45 surrounding the periphery of the joint portion 43 between the first frame 12 and the second frame 14 can be formed without performing the operation of scraping off the adhesive when the first connecting members 16 and the third connecting members 42 are brought into abutment. As a result, the frame joint structure 40 exhibits sufficient joint strength even at the joint portion where the end portion 145 of the second frame 14 is abutted against the first frame 12.

### Fourth Embodiment

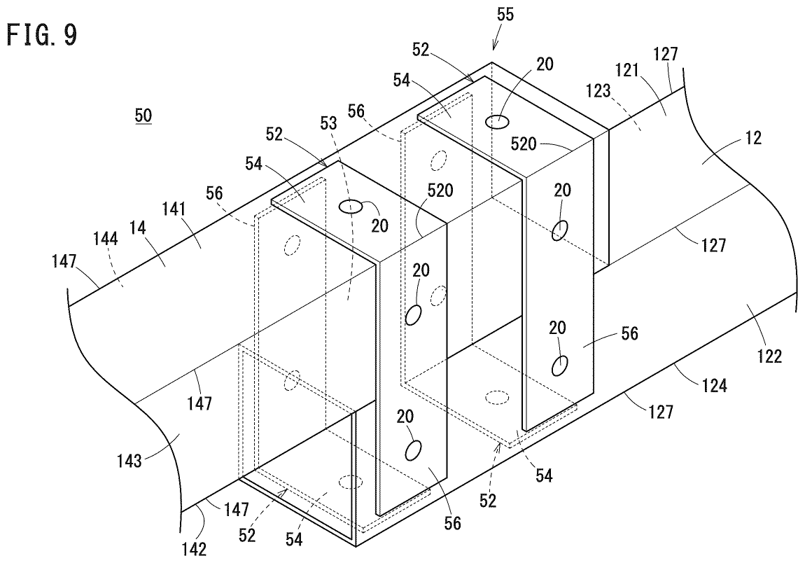

As shown in FIG. 9, a frame joint structure 50 of the present embodiment is applied to a joint portion where the first frame 12 and the second frame 14 overlap each other in an I-shape. It should be noted that, in the frame joint structure 50 of the present embodiment, the same configurations as those of the frame joint structure 10 described with reference to FIGS. 1 to 3 are denoted by the same reference numerals, and detailed description thereof will be omitted.

In the frame joint structure 50, the second frame 14 is disposed parallel to the extending direction of the first frame 12. The sixth surface 142 of the second frame 14 abuts on the first surface 121 of the first frame 12 to form a joint portion 53. Further, the seventh surface 143 of the second frame 14 and the second surface 122 of the first frame 12 form the same plane. Furthermore, the eighth surface 144 of the second frame 14 and the third surface 123 of the first frame 12 form the same plane.

The frame joint structure 50 includes a pair of fourth connecting members 52. Each of the fourth connecting members 52 has an L-shape. The fourth connecting member 52 includes a support surface 54 and a main surface 56. The support surface 54 and the main surface 56 are integrally connected to each other via a bent portion 520. The bent portion 520 is a portion that is bent by 90°. The support surface 54 abuts on the fourth surface 124 of the first frame 12 or the fifth surface 141 of the second frame 14.

The main surface 56 of the fourth connecting member 52 extends across the joint portion 53. The main surface 56 abuts on the first frame 12 and the second frame 14 to connect the first frame 12 and the second frame 14 to each other.

A connecting unit 55 includes at least a pair of fourth connecting members 52. The two fourth connecting members 52 are arranged so as to surround the first frame 12 and the second frame 14 in the circumferential direction. The two fourth connecting members 52 each having an L-shape are disposed so as to face each other with the first frame 12 and the second frame 14 interposed therebetween. Further, as illustrated, the connecting unit 55 may include a plurality of pairs of fourth connecting members 52 in the extending direction of the first frame 12 and the second frame 14.

As described above, the frame joint structure 50 of the present embodiment is configured by combining the fourth connecting members 52 each abutting on two flat surfaces of the first frame 12 or the second frame 14. Therefore, according to the frame joint structure 50, the connecting unit 55 surrounding the periphery of the joint portion 53 can be formed without performing the operation of scraping off the adhesive when the fourth connecting members 52 are brought into abutment. As a result, the frame joint structure 50 exhibits sufficient joint strength even at the joint portion where the first frame 12 and the second frame 14 are connected in an I-shape.

The frame joint structure 10, 30, 40 according to each of the above embodiments has the following effects.

The frame joint structure 10, 30, 40 relates to the frame joint structure 10, 30, 40 that joins together the first frame 12 including the plurality of planar portions on the outer periphery thereof, and the second frame 14 including the plurality of planar portions on the outer periphery thereof. The frame joint structure 10, 30, 40 includes the connecting member (for example, the first connecting member 16) disposed adjacent to the joint portion 13, 33, 43 between the first frame 12 and the second frame 14, the connecting member includes the first joint surface 161 that abuts on only one of the planar portions of the first frame 12, and the second joint surface 162 that is integrally connected to the first joint surface 161 and abuts on only one of the planar portions of the second frame 14, and the connecting member is joined to the first frame 12 and the second frame 14 by the first joining member (for example, the adhesive).

The above frame joint structure 10, 30, 40 can prevent the first joining member from being scraped off by the connecting member, and can exhibit stable joint strength. Further, since welding is not required, the manufacturing cost can be suppressed.

In the above-described frame joint structure 10, 30, 40, the connecting member may include the first reinforcing surface 163 that is formed across the end edge 165 of the first joint surface 161 and the end edge 166 of the second joint surface 162. According to the frame joint structure 10, 30, 40, the strength of the connecting member is improved, and thus the joint strength is improved.

The above-described frame joint structure 10, 30, 40 may further include the second reinforcing surface 164 that is formed across the other end edge 167 of the first joint surface 161 and the other end edge 168 of the second joint surface 162 and faces the first reinforcing surface 163, and the first reinforcing surface 163 and the second reinforcing surface 164 may be joined to another connecting member (for example, the second connecting member 18 or the third connecting member 42) via the second joining member 20. According to this frame joint structure, a joint surface between the reinforcing surfaces can be provided without newly adding a reinforcing surface.

In the above-described frame joint structure 10, 30, the first frame 12 and the second frame 14 may each have a rectangular cross section, one of the planar portions (for example, the first surface 121) of the first frame 12 and one of the planar portions (for example, the sixth surface 142) of the second frame 14 may abut on each other in the joint portion 13, 33, the connecting member (for example, the first connecting member 16) and the second connecting member 18 may be disposed adjacent to the joint portion 13, 33, the second connecting member 18 may include the third joint surface 181 that abuts on the first frame 12, the fourth joint surface 182 that is integrally connected to the third joint surface 181 and is orthogonal to the third joint surface 181, the third reinforcing surface 183 that is formed on the same plane as the third joint surface 181, and the fourth reinforcing surface 184 that is formed on the same plane as the fourth joint surface 182, and at least one of the first reinforcing surface 163 or the second reinforcing surface 164 of the connecting member (for example, the first connecting member 16) may be joined to the third reinforcing surface 183 or the fourth reinforcing surface 184 of the second connecting member 18 by the second joining member 20.

The frame joint structure 10, 30 described above can increase the rigidity by surrounding the joint portion 13, 33 between the first frame 12 and the second frame 14 each having a rectangular cross section, with the plurality of first connecting members 16 and second connecting members 18.

The above-described frame joint structure 10, 30 may include at least two connecting members (for example, the first connecting members 16) and at least one second connecting member 18, and the second connecting member 18 may connect the two connecting members (for example, the first connecting members 16) via the third reinforcing surface 183 and the fourth reinforcing surface 184. The frame joint structure 10, 30 can realize rigidity equivalent to that by a joint including a receiving opening.

In the above-described frame joint structure 40, the first frame 12 and the second frame 14 may each have a rectangular cross section, one of the planar portions (for example, the first surface 121) of the first frame 12 and the end portion 145 of the second frame 14 may abut on each other in the joint portion 43, the connecting member (for example, the first connecting member 16) and the third connecting member 42 may be disposed adjacent to the joint portion 43, the third connecting member 42 may include the fifth joint surface 421 that abuts on the first frame 12, the sixth joint surface 422 that is integrally connected to the fifth joint surface 421 on the same plane and abuts on the second frame 14, the fifth reinforcing surface 423 that is formed at one of the corner portions formed between the fifth joint surface 421 and the sixth joint surface 422 and is integrally connected to the fifth joint surface 421 on the same plane, and the sixth reinforcing surface 424 that is formed at the other of the corner portions formed between the fifth joint surface 421 and the sixth joint surface 422 and is integrally connected to the fifth joint surface 421 on the same plane, and at least one of the first reinforcing surface 163 or the second reinforcing surface 164 of the connecting member (for example, the first connecting member 16) may be joined to the fifth reinforcing surface 423 or the sixth reinforcing surface 424 of the third connecting member 42 via the second joining member 20.

The frame joint structure 40 described above can increase the rigidity by surrounding the joint portion 43 where the end portion 145 of the second frame 14 is abutted against the first frame 12, with the plurality of first connecting members 16 and third connecting members 42.

In the above-described frame joint structure 10, 30, 40, the connecting member (for example, the first connecting member 16) may include the chamfered portion 170 formed by cutting out two surfaces of a cubic shape. In the frame joint structure 10, 30, 40, the first connecting member 16 is downsized, and therefore, interference with other components can be suppressed.

In the above-described frame joint structure 10, 30, 40, the connecting member (for example, the first connecting member 16) may include the single plate member 171 that has been subjected to the bending process. The frame joint structure 10, 30, 40 is easy to manufacture because the first connecting member 16 can be formed by bending the plate member 171 in the shape of a dice development view.

The present invention is not limited to the above disclosure, and various modifications are possible without departing from the essence and gist of the present invention.

1. A frame joint structure that joins together a first frame including a plurality of planar portions on an outer periphery of the first frame, and a second frame including a plurality of planar portions on an outer periphery of the second frame,
the frame joint structure comprising a connecting member disposed adjacent to a joint portion between the first frame and the second frame,
wherein the connecting member includes a first joint surface that abuts on only one of the planar portions of the first frame, and a second joint surface that is integrally connected to the first joint surface and abuts on only one of the planar portions of the second frame, and
the connecting member is joined to the first frame and the second frame by a first joining member.

2. The frame joint structure according to claim 1, wherein
the connecting member includes a first reinforcing surface that is formed across an end edge of the first joint surface and an end edge of the second joint surface.

3. The frame joint structure according to claim 2, wherein
the connecting member includes a second reinforcing surface that is formed across another end edge of the first joint surface and another end edge of the second joint surface and faces the first reinforcing surface, and
the first reinforcing surface and the second reinforcing surface are joined to another connecting member via a second joining member.

4. The frame joint structure according to claim 3, wherein
the first frame and the second frame each have a rectangular cross section,
one of the planar portions of the first frame and one of the planar portions of the second frame abut on each other in the joint portion,
the connecting member and a second connecting member are disposed adjacent to the joint portion,
the second connecting member includes a third joint surface that abuts on the first frame, a fourth joint surface that is integrally connected to the third joint surface and is orthogonal to the third joint surface, a third reinforcing surface that is formed on a same plane as the third joint surface, and a fourth reinforcing surface that is formed on a same plane as the fourth joint surface, and
at least one of the first reinforcing surface or the second reinforcing surface of the connecting member is joined to the third reinforcing surface or the fourth reinforcing surface of the second connecting member by the second joining member.

5. The frame joint structure according to claim 4, comprising at least two of the connecting members and at least one of the second connecting members, wherein
the second connecting member connects the two connecting members via the third reinforcing surface and the fourth reinforcing surface.

6. The frame joint structure according to claim 3, wherein
the first frame and the second frame each have a rectangular cross section,
one of the planar portions of the first frame and an end portion of
the second frame abut on each other in the joint portion,
the connecting member and a third connecting member are disposed adjacent to the joint portion,
the third connecting member includes:
a fifth joint surface that abuts on the first frame;
a sixth joint surface that is integrally connected to the fifth joint surface on a same plane and abuts on the second frame;
a fifth reinforcing surface that is formed at one of corner portions formed between the fifth joint surface and the sixth joint surface, and is integrally connected to the fifth joint surface on the same plane; and
a sixth reinforcing surface that is formed at another of the corner portions formed between the fifth joint surface and the sixth joint surface, and is integrally connected to the fifth joint surface on the same plane, and
at least one of the first reinforcing surface or the second reinforcing surface of the connecting member is joined to the fifth reinforcing surface or the sixth reinforcing surface of the third connecting member by the second joining member.

7. The frame joint structure according to claim 4, wherein
the connecting member includes a chamfered portion formed by cutting out two surfaces of a cubic shape.

8. The frame joint structure according to claim 4, wherein
the connecting member includes a single plate member that has been subjected to a bending process.
